(19) United States
(12) Patent Application Publication
(10) Pub. No.: US 2014/0085532 A1
(43) Pub. Date: Mar. 27, 2014

(54) Corrective optical systems and methods

(71) Applicant: Caldwell Photographic, Inc., Petersburg, VA (US)

(72) Inventor: J. Brian Caldwell, Petersburg, VA (US)

(73) Assignee: Caldwell Photographic, Inc., Petersburg, VA (US)

(21) Appl. No.: 14/024,578

(22) Filed: Sep. 11, 2013

Related U.S. Application Data
(60) Provisional application No. 61/704,785, filed on Sep. 24, 2012.

(51) Int. Cl. G02B 9/10; H04N 5/225

(52) U.S. Cl. CPC G02B 9/10; H04N 5/2254
USPC 348/360; 359/795; 359/642; 29/428

(57) ABSTRACT

A corrective optical system for an imaging optical system is disclosed, wherein the imaging optical system has an objective having a working space, and whose imaging performance is not corrected for one or more plane parallel plates located in the working space. The corrector optical system resides in the working space between the one or more plane parallel plates and objective and serves to reduce the aberrations introduced by the one or more plane parallel plates. The corrector optical system enables objectives originally designed for film to be used with digital cameras.

### CROSS-REFERENCE TO RELATED APPLICATIONS

This application claims priority under 35 USC §119(e) of U.S. Provisional Patent Application Ser. No. 61/704,785, filed on Sep. 24, 2012, and which is incorporated by reference herein.

All references cited herein are incorporated herein by reference.

### FIELD

The present disclosure is directed to corrective optical systems, and in particular to such system and methods for reducing aberrations in a primary or objective lens caused by the use of one or more plane parallel plates.

### BACKGROUND ART

For many decades, photographic and cinematographic objective lenses (“objectives”) have been designed to work optimally with film at the image plane. In this configuration, there are typically no filters or other transparent plane parallel plates (hereinafter “flat plates”) located in the optical path between the objective and the image plane. An exception is telephoto lenses having a large entrance pupil diameter, which often include a rear-mounted filter to avoid having to use a very large and expensive front-mounted filter.

Recently, film cameras have largely been replaced by digital cameras in all areas of image capture, including conventional still photography and cinematography. A nearly universal characteristic of digital cameras is that they incorporate one or more flat plates near the image plane. First of all, nearly all electronic image sensors have a built-in protective coverglass very close to the actual photosensitive surface. The purpose of this coverglass is to protect the delicate electronic circuitry underneath as well as to prevent accumulation of dust etc.

In addition to the sensor coverglass, most digital cameras also include infrared-absorbing filters and anti-aliasing filters. Some advanced digital cameras also include additional filters, such as neutral density filters, in the space between the objective and the sensor. The total thickness of all of these flat plates can range from less than 1 mm to more than 7 mm.

The addition of one or more flat plates between the objective and the image plane introduces aberrations in the case where the objective was not designed to account for the presence of the one or more flat plates.

### SUMMARY

The present disclosure is directed to corrective optical systems and methods for “correcting” (i.e., reducing or substantially eliminating) aberrations caused by one or more plane parallel plates (i.e., “flat plates”) that resides on the image side of an objective. The present disclosure is particularly suitable for modifying objectives originally designed for use with film so that they can be used with digital cameras having an electronic image sensor and a filter pack near the image plane without substantial image degradation.

An aspect of the disclosure is a combination of the corrective optical system, an objective, and at least one plane parallel plate. This combination is referred to below as an “imaging optical system.”

The present disclosure is also directed to a corrective optical system disposed on the image side of an objective to reduce or eliminate aberrations caused by introduction of one or more flat plates into the optical path between the objective and the image plane. The present disclosure is particularly suitable for adapting objective originally designed for SLR film cameras and having a relatively large working distance for use with digital cameras having a smaller permissible working distance and having one or more flat transparent plates located in the optical path near the electronic image sensor surface.

Corrective optical systems designed according to the present disclosure can enable objectives originally designed for film to function on digital cameras with little or no image degradation. In many instances it is possible to improve the MTF of the lens when a filter pack and corrective optical system are added relative to the normal configuration when no filter pack or corrective optical system is present.

The corrective optical system disclosed herein can have from one to four lenses,

An aspect of the disclosure is a corrective optical system for an imaging optical system having an objective and an image plane, consisting of: a first lens element that is bi-convex and having positive power and a refractive index n_{P}; a second lens element that is bi-concave and having negative power and a refractive index n_{N}, wherein n_{P}<n_{N}; wherein the first and second lens elements define an optical power P in the range −4 diopters<P<1 diopter; and wherein the first and second lens elements reduce aberrations in the imaging optical system when at least one flat plate is introduced adjacent the image plane and when the first and second lens elements are operably disposed between the objective and the at least one flat plate.

Another aspect of the disclosure is the corrective optical system as described above, wherein the first lens element defines a most objective-wise lens surface having a radius of curvature Ro, the second lens element defines a most image-plane-wise lens surface having a radius of curvature Ri, and wherein 0<((1/Ro)+(1/Ri))·Ro<3.

Another aspect of the disclosure is the corrective optical system as described above, wherein the objective has a focal length f_{O}, the imaging optical system comprising the objective together with the corrective optical system has a focal length of f_{S}, and wherein 0.85<|f_{S}/f_{O}|<1.20.

Another aspect of the disclosure is the corrective optical system as described above, wherein the corrective optical system is removably attached to the objective.

Another aspect of the disclosure is the corrective optical system as described above, wherein the corrective optical system is permanently attached to the objective.

Another aspect of the disclosure is the corrective optical system as described above, wherein the corrective optical is removably attached to a camera that includes the flat plate.

Another aspect of the disclosure is the corrective optical system as described above, wherein the corrective optical system is permanently attached to a camera that includes the flat plate.

Another aspect of the disclosure is an imaging optical system having an image plane, and that includes in order along an optical axis: an objective having a working space and that is corrected for aberrations in the absence of one or more flat plates within the working space; one or more flat plates arranged in the working space and adjacent the image plane; a corrective optical system arranged within the working space and between the one or more flat plates and the objective, the corrective optical system having an optical power P in the range −4 diopters<P<1 diopter and a magnification M in the range 0.8≦M≦1.2; and wherein the one or more flat plates introduce aberrations into the imaging optical system, and wherein the corrective optical system acts to reduce the aberrations.

Another aspect of the disclosure is an imaging optical system as described above, wherein the corrector optical system is universal.

Another aspect of the disclosure is an imaging optical system as described above, wherein the corrector optical system has from one to four lens elements.

Another aspect of the disclosure is an imaging optical system as described above, wherein the one to four lens elements define a most objective-wise lens surface having a radius of curvature Ro and a most image-plane-wise lens surface having a radius of curvature Ri, and wherein 0<((1/Ro)+(1/Ri))·Ro<3.

Another aspect of the disclosure is an imaging optical system as described above, wherein the one to four lens elements consist of a single meniscus lens element.

Another aspect of the disclosure is an imaging optical system as described above, wherein the one to four lens elements consist of a first lens element that is bi-convex and having positive power and a refractive index n_{P}, and a second lens element that is bi-concave and having negative power and a refractive index n_{N}, and wherein n_{P}<n_{N}.

Another aspect of the disclosure is an imaging optical system as described above, further comprising an electronic image sensor arranged at the image plane.

Another aspect of the disclosure is an imaging optical system that includes, in order along an optical axis: an objective having an image side with a working space, the objective having an imaging performance that assumes there are no plane parallel plates in the working space; a corrective optical system arranged on the image side of the objective, the corrective optical system having one to four lens elements and a magnification M in the range 0.85≦M≦1.2; at least one plane parallel plate arranged between the corrective optical system and the image plane and that introduces into the imaging optical system aberrations that that reduce the imaging performance; an electronic image sensor arranged substantially at the image plane; and wherein the corrective optical system reduces the aberrations introduced into the objective by the one or more plane parallel plates to substantially restore the imaging performance of the objective.

Another aspect of the disclosure is an imaging optical system as described above, wherein the electronic image sensor and the at least one plane parallel plate are housed in a camera housing, and wherein the corrective optical system is adapted to be removably attached to the camera housing, and wherein the objective is adapted to be removably attached to the corrective optical system.

Another aspect of the disclosure is an imaging optical system as described above, wherein the corrective optical system has an optical power P in the range −4 diopters<P<1 diopter.

Another aspect of the disclosure is an imaging optical system as described above, wherein the one to four lens elements consist of a first lens element that is bi-convex and having positive power and a refractive index n_{P}, and a second lens element that is bi-concave and having negative power and a refractive index n_{N}, and wherein n_{P}<n_{N}.

Another aspect of the disclosure is an imaging optical system as described above, wherein the one to four lens elements define a most objective-wise lens surface having a radius of curvature Ro and a most image-plane-wise lens surface having a radius of curvature Ri, and wherein 0<((1/Ro)+(1/Ri))·Ro<3.

Another aspect of the disclosure is an imaging optical system as described above, wherein the one to four lens elements consist of a single meniscus lens element.

Another aspect of the disclosure is a method of employing an objective designed for use with film on a digital camera having a flat plate and an electronic image sensor. The method includes: attaching a corrective optical system to the digital camera; attaching the objective to the corrective optical system so that the corrective optical system operably resides between the objective and the flat plate; and wherein the flat plate introduces aberrations to the objective, and wherein the corrective optical system acts to reduce the aberrations.

Another aspect of the disclosure the method as described above, wherein the corrective optical system has from one to four lens elements.

Another aspect of the disclosure is the method as described above, wherein the one to four lens elements define a most objective-wise lens surface having a radius of curvature Ro and a most image-plane-wise lens surface having a radius of curvature Ri, and wherein 0<((1/Ro)+(1/Ri))·Ro<3.

Another aspect of the disclosure is the method as described above, wherein the one to four lens elements consist of a single meniscus lens element.

Another aspect of the disclosure is the method as described above, wherein the digital camera comprises a 35 mm camera.

Another aspect of the disclosure is the method as described above, wherein the one to for lens elements consist of a bi-convex lens element having positive power and a refractive index n_{P}, and a bi-concave lens element and having negative power and a refractive index n_{N}, and wherein n_{P}<n_{N}.

Another aspect of the disclosure is the method as described above, wherein the corrective optical system has an optical power P in the range −4 diopters<P<1 diopter and a magnification in the range 0.85≦M≦1.2.

Another aspect of the disclosure is a corrective optical system for an imaging optical system having an objective with a working space and an image plane. The system includes: one to four lens elements that define a most objective-wise lens surface having a radius of curvature Ro and a most image-plane-wise lens surface having a radius of curvature Ri; wherein 0<((1/Ro)+(1/Ri))·Ro<3; and wherein the one to for lens elements act to reduces aberrations in the imaging optical system when at least one flat plate resides in the workspace adjacent an image plane and when the corrective optical system is operably disposed in the working space between the objective and the at least one flat plate.

Another aspect of the disclosure is the corrective optical system as described above, wherein the one to four lens elements define an optical power P in the range −4 diopters<P<1 diopter and a magnification in the range 0.85≦M≦1.2.

Another aspect of the disclosure is the corrective optical system as described above, wherein the one to four lens elements consist of a first objective-wise lens element that is bi-convex and having positive power and a refractive index n_{P}, and a second image-plane-wise lens element that is bi-concave and having negative power and a refractive index n_{N}, and wherein n_{P}<n_{N}.

Another aspect of the disclosure is the corrective optical system as described above, wherein the one to four lens elements consist of a single meniscus lens element.

Another aspect of the disclosure is the corrective optical system as described above, wherein the one to four lens elements consist of a most objective-wise meniscus lens element and a most image-plane-wise doublet.

Another aspect of the disclosure is the corrective optical system as described above, wherein the one to four lens elements consist of two doublets.

Another aspect of the disclosure is the corrective optical system as described above, and further comprising an electronic image sensor arranged at the image plane.

### BRIEF DESCRIPTION OF THE DRAWINGS

FIG. 1 is a layout of Example 1 of the corrective optical system disclosed herein.

FIG. 2 is a plot of MTF vs. Image Height for a perfect f/2 lens covering 35 mm cinematography (“cine”) format plus a 7 mm BSL7 plane parallel plate with and without the Example 1 corrective optical system.

FIG. 3 is a layout of Example 2 of the corrective optical system disclosed herein.

FIG. 4 is a plot of MTF vs. Image Height for a perfect f/1.4 objective covering the full frame (24 mm×36 mm) 35 mm format plus a 7 mm BSL7 plane parallel plate with and without the Example 2 corrective optical system.

FIG. 5 is a layout of an Example 3 corrective optical system as disclosed herein, and as attached to an 85 mm f/1.4 objective.

FIG. 6 is a plot of MTF vs. Image Height for an 85 mm f/1.4 objective covering the full frame 35 mm format (24 mm×36 mm) under the following conditions: 1) used alone in its normal configuration without any flat plates between the lens and the image; 2) used with a 7 mm BSL7 plate without any corrective optical system; and 3) used with a 7 mm BSL7 plate with a corrective optical system.

FIG. 7 is a layout of an Example 4 corrective optical system as disclosed herein.

FIG. 8 is a plot of MTF vs. Image Height for a perfect f/1.4 objective covering the full frame (24 mm×36 mm) 35 mm format plus a 7 mm BSL7 plane parallel plate with and without the Example 4 corrective optical system.

FIG. 9 is a layout of an Example 5 corrective optical system as disclosed herein.

FIG. 10 is a plot of MTF vs. Image Height for a perfect f/1.4 objective covering the full frame (24 mm×36 mm) 35 mm format plus a 7 mm BSL7 plane parallel plate with and without the Example 5 corrective optical system.

FIG. 11 is a layout of an Example 6 corrective optical system as disclosed herein.

FIG. 12 is a plot of MTF vs. Image Height for a perfect f/1.4 objective covering the full frame (24 mm×36 mm) 35 mm format plus a 7 mm BSL7 plane parallel plate with and without the Example 6 corrective optical system.

### DETAILED DESCRIPTION

The present disclosure is directed to a corrective optical system placed on the image side of an objective in order to reduce or eliminate aberrations caused by introduction of one or more flat transparent plates into the optical path between the objective and the image plane.

It is well known that a plane parallel plate placed in converging light beam will introduce a variety of aberrations, including spherical aberration, coma, astigmatism, longitudinal chromatic aberration and lateral chromatic aberration. Therefore, if a lens designed for film (i.e., for the case where there are no flat plates located between the rearmost powered lens surface and the image plane) is mounted to a digital camera having one or more flat plates, then aberrations will be introduced that can degrade the optical performance of the digital camera.

High-power microscope objectives are often designed to be compatible with a specific coverslip thickness, usually 0.17 mm. If the objective is used with a subject (object) having no coverslip, or with a coverslip having a thickness that is different from the nominal design value, then significant amount of aberration will be introduced that will degrade the image quality of the objective. In microscopy, where the field of view is small and the numerical aperture is large, the most harmful aberration introduced by a non-optimal coverslip thickness is spherical aberration. Some microscope objectives have movable lens elements that can be controlled by an external collar or other mechanical device, the function of which is to vary the spherical aberration so that the objective can be optimized to work with a variety of coverslip thicknesses.

In the case of photographic and cinematographic objectives, where there is a very large population of existing lenses that are optimized for film, it is desirable to be able to modify the lens in some fashion so that the aberrations introduced by the flat plates in a digital camera can be either minimized (reduced) or overcome altogether when the lens is mounted to the digital camera. Unfortunately, few if any existing objectives have adjustable aberration-correction means comparable to that found in some microscope objectives. It would therefore be desirable to add corrective optics either to the front or rear of such lenses to compensate for aberrations from the one or more flat (plane parallel) plates.

A large number of existing film lenses have been designed for SLR cameras. Such cameras have a swinging reflex mirror located between the lens and the image plane. The reflex minor serves to temporarily divert the optical path to a viewfinder system so that the user can view a scene through the lens. Lenses for SLR cameras therefore have a relatively large rear working distance. If these SLR lenses are used on digital SLR cameras, the large working distance must be maintained, and any corrective optics to compensate for flat plate aberrations must be placed in front of the lens. Unfortunately, because the object-space marginal ray height and chief ray angle vary considerably for different focal length lenses, it is not practical to design front-mounted compensating optics that can work well with all existing lenses.

Recent advances in electronic viewfinders have resulted in a new type of interchangeable lens camera that has no need for a reflex mirror. Such cameras are commonly called “mirrorless cameras,” which typically have a very short lens-flange to image-plane distance as compared with SLR cameras having a similar image size. Examples of mirrorless cameras include the Micro Four Thirds cameras manufactured by Olympus and Panasonic, the Sony NEX series cameras, and the Samsung NX series cameras. Although these cameras are primarily intended for still photography, mirrorless cinematography cameras are also becoming more popular and are available from a number of commercial lens manufacturers.

The flange distance (i.e., the distance from the lens flange to the image plane)—in all of these types of cameras is relatively small. In Micro Four Thirds cameras, the flange distance is approximately 20 mm, and in Sony NEX cameras the flange distance is approximately 18 mm. By contrast, the flange distance in 35 mm SLR cameras with a Nikon F mount is 46.5 mm. The large difference between the flange distance of SLR cameras and mirrorless cameras allows for the design and implementation of corrective optics that fit in the large space formerly occupied by a reflex mirror. However, to date, no such corrective optics have been developed that are generally applicable to long-working-distance film lenses to adapt them for use on mirrorless digital cameras to reduce or eliminate aberrations introduced by the plane parallel plate elements almost always used in such digital cameras.

Thus, there is a need for a corrective optical system to compensate for flat plate aberrations introduced when a lens originally designed for film is mounted to a digital camera having one or more transparent flat plates in the optical path near the sensor. Additionally, there is a need for the corrective optical system to fit behind the rearmost powered lens surface of long-working-distance objectives when these objectives are mounted to a mirrorless digital camera. Additionally, there is a need for the corrective optical systems to have a universal design that will function with a wide variety of objective. Finally, there is a need for customized corrective optical systems that are optimized to work best with a particular objective.

An advantage of locating a corrective optical system behind an objective is that they can be designed to be universal, meaning that they will function well for nearly any lens covering the format, regardless of focal length, aperture, or field of view. An advantage of a universal corrective optical system is that it can either be attached to the camera or else attached to the rear of each lens requiring correction. The attachment means may be reversible, by the use of threaded or bayonet mounts, or the like.

Alternatively, the attachment means may be permanent, so that the corrective optics are not easily removed from the camera or lens. Another advantage of a universal corrective optical system is that it can be used for a wide range of objectives regardless of the design of those objectives. This means that the corrective optics may be designed without any knowledge of the design data for the objective. A universal, or general-purpose, corrective optical system is best designed by assuming the objective has no aberrations except for those introduced by a flat plate. An example of such an objective is a paraxial lens, which can be readily modeled using commercial lens design software such as ZEMAX, by Radiant Zemax, LLC of Redmond, Wash.

Although a universal corrective optical system has clear advantages, it is generally possible to achieve better results by optimizing the corrective optical system to work with a particular objective design. This approach requires detailed knowledge of the objective design. In general, the corrective optical system designed according to this approach may not work as well for a broad range of objectives as would a universal corrector.

When designing the corrective optical system, it is important to maintain sufficient working distance on both sides of the optical system. This is particularly important when designing a universal corrector to be used with a wide variety of objective. In this case, the corrector should be fully compatible with the objective having the smallest working distance.

### Corrector Example 1

FIG. 1 is an optical diagram of an imaging optical system 100 that includes, along an axis A1, a perfect or ideal objective (“objective”) 101, a flat plate 104, and a first example (Example 1) corrective optical system (“corrector”) 105, which resides between the objective and the flat plate. Imaging optical system 100 has an image plane 106. Objective 100 has a working space WS between the objective 101 (more specifically, the rearmost lens element of the objective) and image plane 106. The working space WS has an associated working distance WD.

Corrector 105 is designed to be universal, which means that it can correct the aberrations introduced into a perfect objective 101 by flat plate 104. The perfect objective 101 is aberration-free only when it is used by itself, i.e., without any flat plates in the working space WS. Adding the flat plate 104 introduces a range of aberrations, including spherical aberration, coma, astigmatism, longitudinal chromatic aberration, and lateral chromatic aberration.

In an example, objective 101 has a focal length f_{O}, the imaging optical system 100 has a focal length of f_{S}, and wherein 0.85<|f_{S}/f_{O}|<1.20. The parameter |f_{S}/f_{O}|=M, the corrector magnification. It is also useful to define a curvature parameter

C=((1/Ro)+1/(Ri))·Ro,

where Ro is the radius of curvature of the surface of the corrector 105 that is closest to the objective 101 (i.e., the most objective-wise lens surface), and Ri is the radius of curvature of the surface of the corrector 105 that is closest to the image plane 106 (i.e., the most image-plane-wise surface). In the case of Example 1, C=1.785, but in designing a variety of corrector systems it has been found useful to allow C to vary between zero and 3, i.e., 0<C<3.

In Example 1, corrector 105 comprises, in order along axis A1 from objective 101 toward image plane 106 (i.e., on the “image side” of the objective), a bi-convex positive-powered lens element 102 and a bi-concave negative powered lens element 103. Corrector 105 also includes an aperture stop STO, which is located at objective 101, as discussed below.

In an example, to maximize the use of the available working space WS, corrector 105 has slightly negative optical power. This in turn requires that the positive element 102 be made from a material having a lower index of refraction than the negative element 103 to avoid introducing backward field curvature. As a result, the image plane 106 can be planar.

Note that it is also possible to intentionally introduce backward field curvature either by increasing the refractive index of element 102 or by reducing the refractive index of element 103, or both. One situation in which it might be desirable to intentionally introduce backward field curvature is if an electronic image sensor (dashed outline) 107 located at the image plane 106 has a convex curvature. Another situation is if the objective 101 has inward field curvature and it is desired to compensate for this curvature using corrector 105.

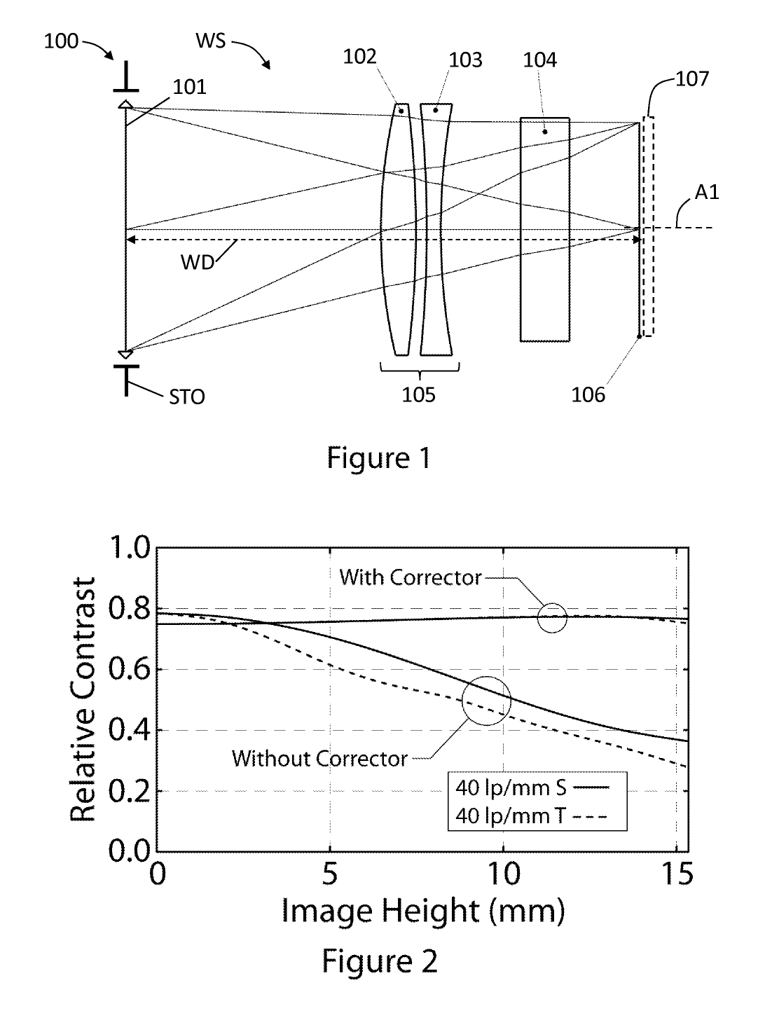

FIG. 2 shows two different plots of MTF vs. Image Height at a spatial frequency of 40 lp/mm, where “lp” stands for “line pairs.” The relative contrast for sagittal S and tangential T rays are shown as solid and dashed lines, respectively. The two plots are shown on the same graph so that they may be easily compared. The first plot, labeled “Without Corrector” shows how the imaging performance of a 70 mm effective focal length (EFL) perfect objective 101 is degraded by the presence of a 7 mm thick flat plate 104 made of S-BSL7 glass having a refractive index of 1.51633. The second plot, labeled “With Corrector” shows how corrector 105 dramatically improves the performance of objective 101 when the flat plate 104 is used. In this example, corrector 105 substantially restores the imaging performance of objective 101 to its original condition. In other cases, such as Example 3 below, the corrector can improve the imaging performance to be beyond the original condition.

Detailed prescription data for the corrector 105 of Example 1 is set forth in Table 1A below. Specification data for Example 1 is given in Table 1B below. Note that all optical surfaces are either spherical or plano. The perfect objective 101 can be conveniently modeled as a paraxial lens. The radius R, thickness T and diameter D values are all in millimeters. The column “type” stands for the type of surface, where “SPH” stands for spherical, “FLT” stands for flat, and PAR stands for paraxial.

TABLE 1A
Prescription Data for Example 1

| | | | Thick- | | |
|---|---|---|---|---|---|
| Surf. | | Radius | ness | Glass | |
| # | Type | R | T | (n_{d}, ν_{d}) | Dia. D |
| OBJ | | INF | INF | | |
| STO | PAR | INF | 36.5 | | |
| | (EFL = 70 mm) | | | | |
| 2 | SPH | 78.307 | 5.000 | 1.51742, 52.4 | 36.0 |
| 3 | SPH | −144.198 | 1.559 | | 36.0 |
| 4 | SPH | −181.391 | 2.000 | 1.78800, 47.3 | 36.0 |
| 5 | SPH | 99.747 | 11.400 | | 36.0 |
| 6 | SPH | INF | 7.000 | 1.51633, 64.1 | 32.0 |
| 7 | SPH | INF | 10.000 | | 32.0 |
| IMG | FLT | INF | | | 30.70 |

TABLE 1B
Specification Data for Example 1
EXAMPLE 1 - SPECIFICATIONS

| | |
|---|---|
| Corrector Magnification | 0.998x |
| Corrector Power (diopters) | −1.61 |
| Ro | 78.307 |
| Ri | 99.747 |
| C = (1/Ro + 1/Ri) · Ro | 1.785 |
| Aperture Ratio | f/2.0 |
| Image Diagonal | 30.70 mm |

By placing the aperture stop STO at the (paraxial) 70 mm EFL objective 101, the exit pupil is thus located 70 mm from the image plane when no corrector is in place. The corrector 105 is therefore automatically optimized to function for an objective having an exit pupil distance of 70 mm, located to the object side of the image plane 106. However, corrector 105 of Example 1 may be used with good results with objectives 101 having exit pupil distances ranging from 40 mm to infinity (telecentric), so that the precise location of aperture stop STO is not critical to the performance of corrector 105.

The corrector 105 of Example 1 is optimized for objective 101 having an aperture of f/2.0 covering an image diagonal of 30.7 mm, which are typical specifications for cinematography objectives. Although corrector 105 is designed for objective 101 having an aperture ratio of f/2.0, the correction of spherical aberration and other aberrations is sufficiently good that the corrector can be used with excellent results for objectives 101 having an aperture as fast as f/1.7 or even f/1.4. Thus, corrector 105 according to Example 1 is truly a universal corrector for cinematographic optics. Experiments with a variety of objectives designed for use with film have shown that corrector 105 will almost always fully recover the original on-film performance of the objective when a 7 mm BSL7 flat plate 104 is added.

### Example 2

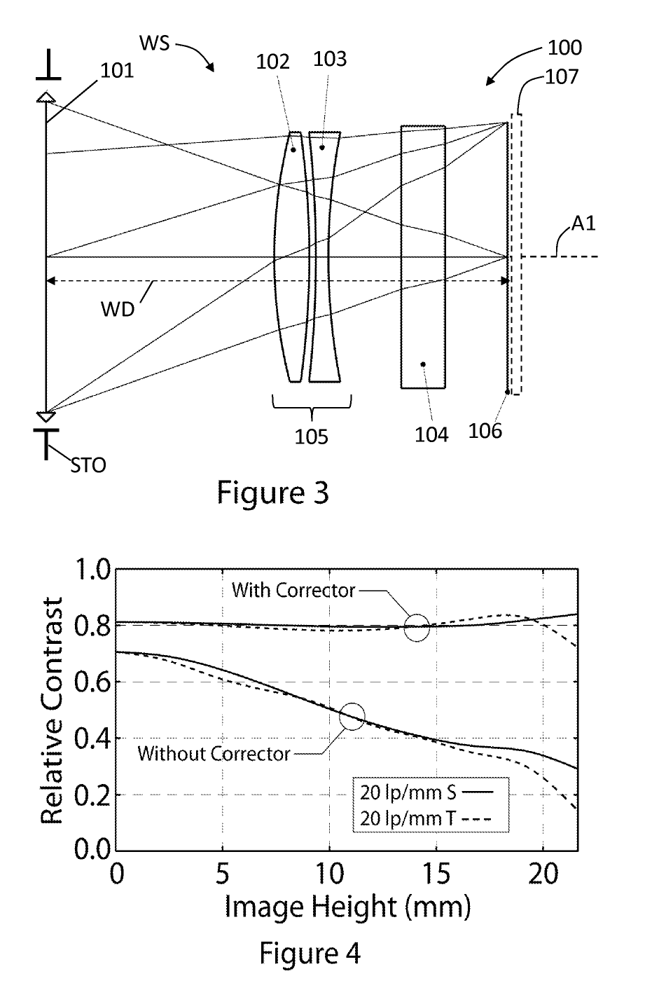

FIG. 3 shows a second example (Example 2) of imaging optical system 100, wherein corrector 105 is optimized for a large aperture (f/1.4) and large image diagonal (43.26 mm). Corrector 105 of Example 2 is thus suitable for use with a full-frame 35 mm format (24 mm×36 mm) objective 101.

Corrector 105 of Example 2 is also designed as a universal corrector. Corrector 105 comprises, in order along axis A1 from objective 101 to image plane 106, a bi-convex positive powered lens element 102 and a bi-concave negative powered lens element 103.

To maximize the use of the available working space WS, corrector 105 has slightly negative optical power. This in turn requires that the positive element 102 be made from a material having a lower index of refraction than the negative element 103 to avoid introducing backward field curvature. As a result, the image plane 106 can be planar.

FIG. 4 shows two different plots of MTF vs. Image Height at a spatial frequency of 20 lp/mm. The two plots are shown on the same graph so that they may be easily compared. The relative contrast for sagittal S and tangential T rays are shown as solid and dashed lines, respectively. The first plot, labeled “Without Corrector” shows how a 70 mm EFL perfect lens is degraded by the presence of a 7 mm thick flat plate 104 made of S-BSL7 glass having a refractive index of 1.51633. The second plot, labeled “With Corrector” shows how corrector 105 dramatically improves the performance of objective 101 when the flat plate 104 is used.

Detailed prescription data for Example 2 is set forth in Table 2A below. Specification data for Example 2 is given in Table 2B below. Note that all optical surfaces are either spherical or plano. The perfect lens can be conveniently modeled as a paraxial lens using Zemax optical design software.

TABLE 2A
Prescription Data for Example 2

| | | | | GLASS | |
|---|---|---|---|---|---|
| S# | TYPE | R | T | (n_{d}, ν_{d}) | D |
| OBJ | | INF | INF | | |
| STO | PAR | INF | 36.5 | | |
| | (EFL = 70 mm) | | | | |
| 2 | SPH | 81.142 | 5.612 | 1.51742, 52.4 | 40.0 |
| 3 | SPH | −145.403 | 1.049 | | 40.0 |
| 4 | SPH | −184.942 | 2.000 | 1.78800, 47.3 | 40.0 |
| 5 | SPH | 105.647 | 11.660 | | 40.0 |
| 6 | SPH | INF | 7.000 | 1.51633, 64.1 | 42.0 |
| 7 | SPH | INF | 10.000 | | 42.0 |
| IMG | FLT | INF | | | 43.26 |

TABLE 2B
Specification Data for Example 2
EXAMPLE 2 - SPECIFICATIONS

| | |
|---|---|
| Corrector Magnification | 0.997x |
| Corrector Power (diopters) | −1.42 |
| Ro | 81.142 |
| Ri | 105.647 |
| C = (1/Ro + 1/Ri) · Ro | 1.768 |
| Aperture Ratio | f/1.4 |
| Image Diagonal | 43.26 mm |

By placing the aperture stop STO at the (paraxial) 70 mm EFL objective 101, the exit pupil is thus located 70 mm from the image plane when no corrector is in place. The corrector 105 is therefore automatically optimized to function for an objective having an exit pupil distance of 70 mm, located to the object side of the image plane 106. However, the corrector 105 according to Example 2 may be used with good results with objectives 101 having exit pupil distances ranging from 45 mm to 200 mm. In addition, although the corrector 105 is optimized for an f/1.4 objective 101, it may be used with good results with objectives as fast as f/1.2 or even f/1.0.

### Example 3

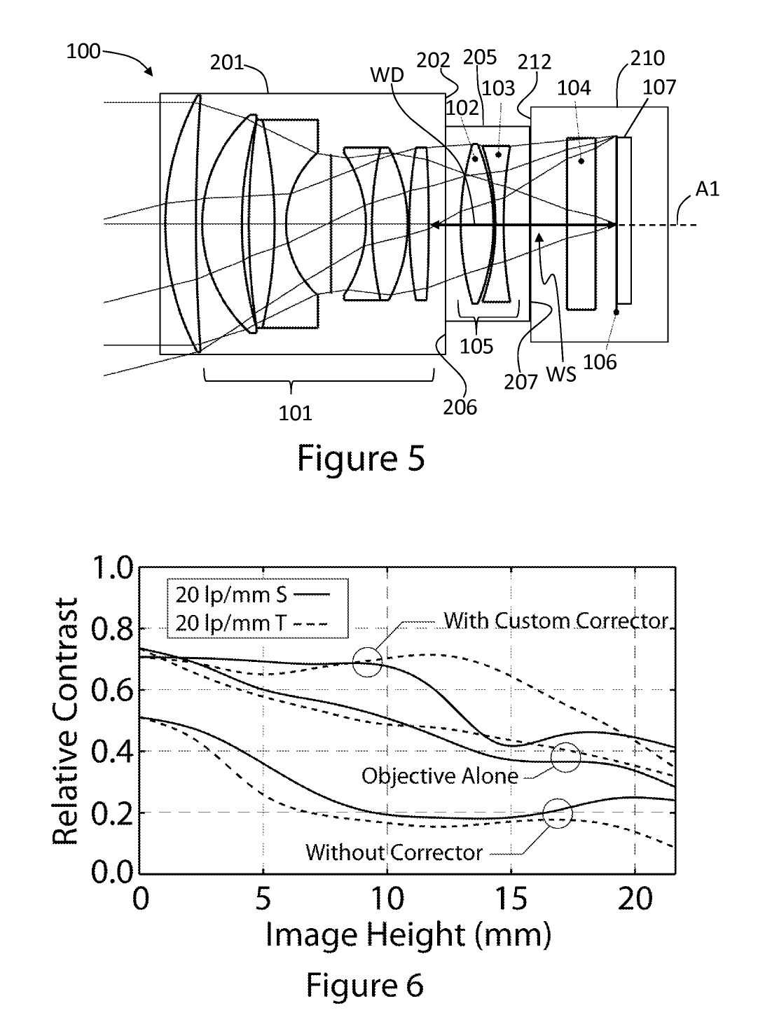

FIG. 5 illustrates a third example (Example 3) of imaging optical system 100, wherein corrector 105 is designed as a custom corrector for a particular objective 101. Consequently, corrector 105 is optimized to correct the aberrations introduced by flat plate 104 in a known objective 101. The example known objective 101 is an 85 mm f/1.4 design taken from the public domain patent literature, in this case U.S. Pat. No. 4,396,256, example #3 of 4. This design corresponds approximately to an 85 mm f/1.4 lens manufactured by Nikon, Inc. The corrective optical system 105 comprises, in order from objective 101 to image plane 106, a bi-convex positive-powered lens element 102 and a bi-concave negative powered lens element 103.

FIG. 6 shows three different plots of MTF vs. Image Height at a spatial frequency of 20 lp/mm. The three plots are shown on the same graph so that they may be easily compared. The relative contrast for sagittal S and tangential T rays are shown as solid and dashed lines, respectively. The first plot, labeled “Without Corrector” shows how the objective 101 is degraded by the presence of a 7 mm thick flat plate 104 made of S-BSL7 glass having a refractive index of 1.51633. The second plot, labeled “Objective Alone” shows the performance of the objective 101 without the plane parallel plate 104 and without corrector 105. The third plot, labeled “With Custom Corrector” shows corrector 105, together with the flat plate 104, improves the performance of the objective 101 to beyond that of its original condition. In an example, corrector 105 substantially restores the imaging performance of objective 101 to its original condition, and in some cases can improve the imaging performance to be beyond the original condition. In the present Example 3, the plots of FIG. 6 illustrate an example of how corrector 105 can improve imaging performance beyond the original condition (i.e., “objective alone” vs. “with custom corrector”)

Detailed prescription data for Example 3 is given in Table 3A below. Specification data for Example 3 is given in Table 3B below. Note that all optical surfaces are either spherical or plano.

TABLE 3A
Prescription Data for Example 3

| | | | | GLASS | |
|---|---|---|---|---|---|
| S# | TYPE | R | T | (n_{d}, ν_{d}) | D |
| OBJ | | INF | INF | | |
| 1 | SPH | 67.018 | 7.500 | 1.74810, 52.3 | 62.900 |
| 2 | SPH | 438.277 | 1.500 | | 62.900 |
| 3 | SPH | 36.446 | 9.700 | 1.69680, 55.6 | 53.550 |
| 4 | SPH | 91.897 | 1.700 | | 50.982 |
| 5 | SPH | 171.384 | 6.298 | 1.80518, 25.5 | 50.982 |
| 6 | SPH | −109.992 | 2.796 | 1.75520, 27.5 | 50.982 |
| 7 | SPH | 23.697 | 10.998 | | 35.154 |
| STO | SPH | INF | 8.500 | | 34.180 |
| 9 | SPH | −31.185 | 1.496 | 1.58144, 40.8 | 34.850 |
| 10 | SPH | 84.995 | 8.704 | 1.74443, 49.4 | 37.400 |
| 11 | SPH | −40.253 | 0.400 | | 37.400 |
| 12 | SPH | 105.998 | 4.802 | 1.74443, 49.4 | 37.400 |
| 13 | SPH | −304.674 | 7.787 | | 37.400 |
| 14 | SPH | 67.996 | 8.000 | 1.51742, 52.4 | 40.0 |
| 15 | SPH | −51.521 | 0.495 | | 40.0 |
| 16 | SPH | −58.183 | 2.000 | 1.78800, 47.3 | 40.0 |
| 17 | SPH | 116.866 | 10.532 | | 40.0 |
| 18 | SPH | INF | 7.000 | 1.51633, 64.1 | 42.0 |
| 19 | SPH | INF | 10.000 | | 42.0 |
| IMG | FLT | INF | | | 43.26 |

TABLE 3B
Specification Data for Example 3
EXAMPLE 3 - SPECIFICATIONS

| | |
|---|---|
| Corrector Magnification | 0.998x |
| Corrector Power (diopters) | −2.03 |
| Ro | 67.996 |
| Ri | 116.866 |
| C = (1/Ro + 1/Ri) · Ro | 1.582 |
| Aperture Ratio | f/1.4 |
| Image Diagonal | 43.26 mm |

FIG. 5 also shows objective 101 having a lens barrel 201 with a back end 202. corrector 105 has a housing 205 with front and back ends 206 and 207. Imaging optical system 100 also includes a camera housing 210 having a front end 212 and that operably supports flat plate 104, and electronic imaging sensor 107 at image plane 106. The back end 207 of corrector housing 205 is configured to be removably attached the front end 212 of camera housing 210, while the back end 202 of lens barrel 201 is configured to be removably attached the front end 206 of corrector housing 205. The removable attachments can be accomplished using any of the attachment means in the art.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

### Example 4

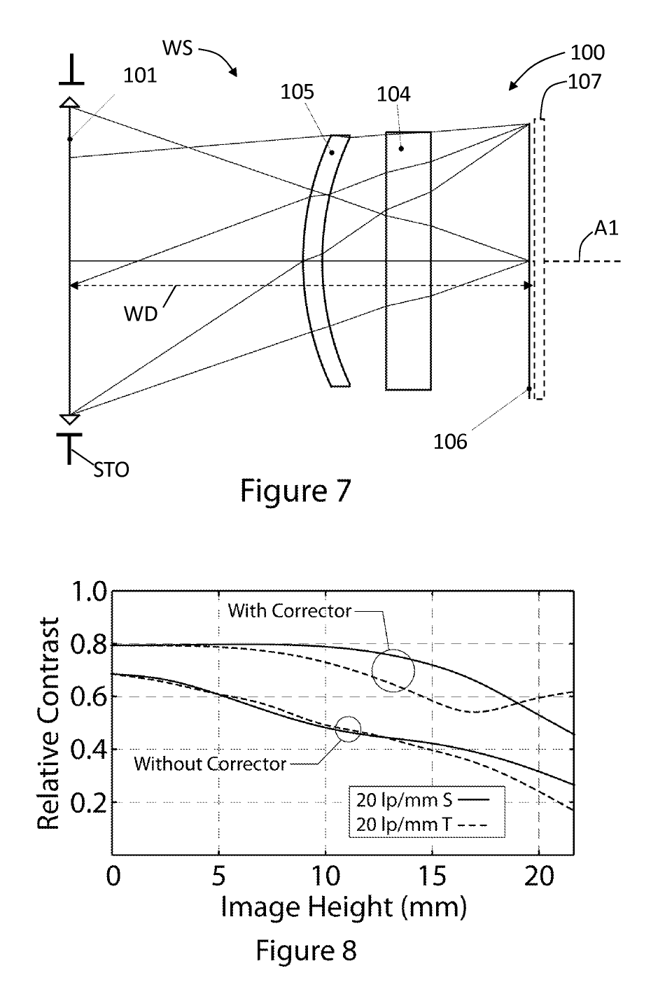

FIG. 7 shows a fourth example (Example 4) of imaging optical system 100, wherein corrector 105 is optimized for a large aperture (f/1.4) and large image diagonal (43.26 mm). Corrector 105 of Example 4 is thus suitable for use with a full-frame 35 mm format (24 mm×36 mm) objective 101.

Corrector 105 of Example 4 is also designed as a universal corrector. Corrector 105 comprises, in order along axis A1 from objective 101 to image plane 106, a single weak meniscus lens element 105.

FIG. 8 shows two different plots of MTF vs. Image Height at a spatial frequency of 20 lp/mm. The two plots are shown on the same graph so that they may be easily compared. The relative contrast for sagittal S and tangential T rays are shown as solid and dashed lines, respectively. The first plot, labeled “Without Corrector” shows how a 70 mm EFL perfect lens is degraded by the presence of a 7 mm thick flat plate 104 made of S-BSL7 glass having a refractive index of 1.51633. The second plot, labeled “With Corrector” shows how corrector 105 improves the performance of objective 101 when the flat plate 104 is used. Although the performance increase with such a simple corrector is not as great as with more complex correctors, the results clearly show that the simple single-lens corrector is a worthwhile addition.

Detailed prescription data for Example 4 is set forth in Table 4A below. Specification data for Example 4 is given in Table 4B below. Note that all optical surfaces are either spherical or plano. The perfect lens can be conveniently modeled as a paraxial lens using Zemax optical design software.

TABLE 4A
Prescription Data for Example 4

| | | | | GLASS | |
|---|---|---|---|---|---|
| S# | TYPE | R | T | (n_{d}, ν_{d}) | D |
| OBJ | | INF | INF | | |
| STO | PAR | INF | 36.5 | | |
| | (EFL = 70 mm) | | | | |
| 2 | SPH | 46.588 | 3.000 | 1.61800, 63.3 | 40.0 |
| 3 | SPH | 45.936 | 10.000 | | 40.0 |
| 4 | SPH | INF | 7.000 | 1.51633, 64.1 | 42.0 |
| 5 | SPH | INF | 15.406 | | 42.0 |
| IMG | FLT | INF | | | 43.26 |

TABLE 4B
Specification Data for Example 4
EXAMPLE 4 - SPECIFICATIONS

| | |
|---|---|
| Corrector Magnification | 0.971x |
| Corrector Power (diopters) | +0.14 |
| Ro | 46.588 |
| Ri | 45.936 |
| C = (1/Ro + 1/Ri) · Ro | 2.014 |
| Aperture Ratio | f/1.4 |
| Image Diagonal | 43.26 mm |

By placing the aperture stop STO at the (paraxial) 70 mm EFL objective 101, the exit pupil is thus located 70 mm from the image plane when no corrector is in place. The corrector 105 is therefore automatically optimized to function for an objective having an exit pupil distance of 70 mm, located to the object side of the image plane 106. However, the corrector 105 according to Example 4 may be used with good results with objectives 101 having exit pupil distances ranging from 45 mm to about 200 mm.

### Example 5

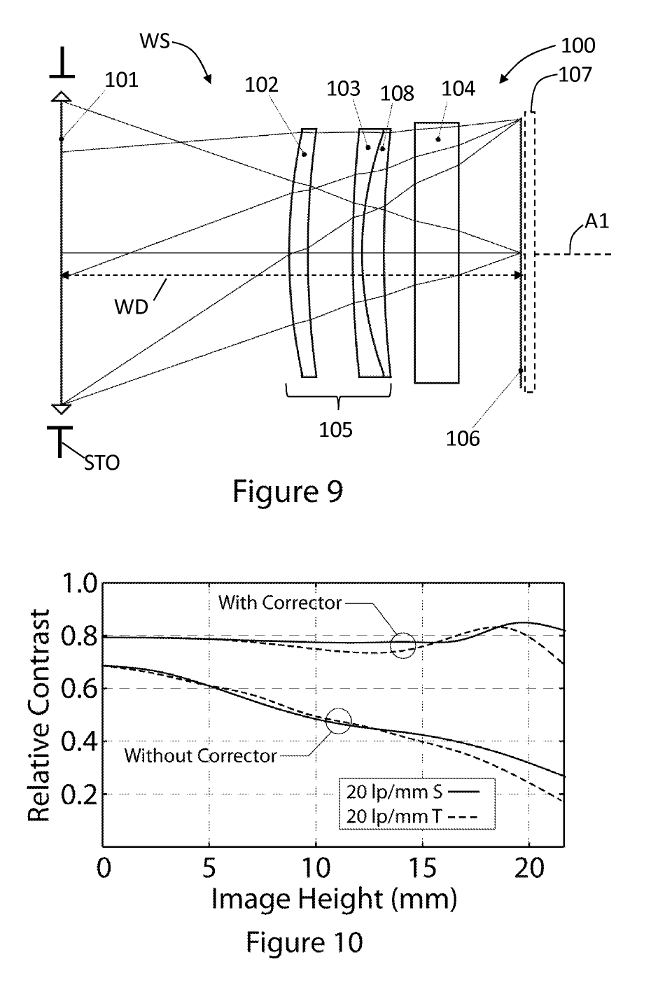

FIG. 9 shows a fifth example (Example 5) of imaging optical system 100, wherein corrector 105 is optimized for a large aperture (f/1.4) and large image diagonal (43.26 mm). Corrector 105 of Example 5 is thus suitable for use with a full-frame 35 mm format (24 mm×36 mm) objective 101.

Corrector 105 of Example 5 is also designed as a universal corrector. Corrector 105 comprises, in order along axis A1 from objective 101 to image plane 106, a meniscus positive powered lens element 102, a meniscus negative powered lens element 103 and a meniscus positive powered lens element 108 cemented to the image-facing surface of lens element 103.

To maximize the use of the available working space WS, corrector 105 has slightly negative optical power. This in turn requires that the positive elements 102 and 108 be made from a material having a lower index of refraction than the negative element 103 to avoid introducing backward field curvature. As a result, the image plane 106 can be planar.

FIG. 10 shows two different plots of MTF vs. Image Height at a spatial frequency of 20 lp/mm. The two plots are shown on the same graph so that they may be easily compared. The relative contrast for sagittal S and tangential T rays are shown as solid and dashed lines, respectively. The first plot, labeled “Without Corrector” shows how a 70 mm EFL perfect lens is degraded by the presence of a 7 mm thick flat plate 104 made of S-BSL7 glass having a refractive index of 1.51633. The second plot, labeled “With Corrector” shows how corrector 105 dramatically improves the performance of objective 101 when the flat plate 104 is used.

Detailed prescription data for Example 5 is set forth in Table 5A below. Specification data for Example 5 is given in Table 5B below. Note that all optical surfaces are either spherical or plano. The perfect lens can be conveniently modeled as a paraxial lens using Zemax optical design software.

TABLE 5A
Prescription Data for Example 5

| | | | | GLASS | |
|---|---|---|---|---|---|
| S# | TYPE | R | T | (n_{d}, ν_{d}) | D |
| OBJ | | INF | INF | | |
| STO | PAR | INF | 36.5 | | |
| | (EFL = 70 mm) | | | | |
| 2 | SPH | 92.621 | 3.000 | 1.72000, 50.2 | 40.0 |
| 3 | SPH | 146.478 | 7.190 | | 40.0 |
| 4 | SPH | 188.955 | 1.500 | 1.88300, 40.8 | 40.0 |
| | | 56.708 | 3.500 | 1.53172, 48.8 | 40.0 |
| 5 | SPH | 184.265 | 4.965 | | 40.0 |
| 6 | SPH | INF | 7.000 | 1.51633, 64.1 | 42.0 |
| 7 | SPH | INF | 10.000 | | 42.0 |
| IMG | FLT | INF | | | 43.26 |

TABLE 5B
Specification Data for Example 5
EXAMPLE 2 - SPECIFICATIONS

| | |
|---|---|
| Corrector Magnification | 0.981x |
| Corrector Power (diopters) | −1.26 |
| Ro | 92.621 |
| Ri | 184.265 |
| C = (1/Ro + 1/Ri) · Ro | 1.503 |
| Aperture Ratio | f/1.4 |
| Image Diagonal | 43.26 mm |

By placing the aperture stop STO at the (paraxial) 70 mm EFL objective 101, the exit pupil is thus located 70 mm from the image plane when no corrector is in place. The corrector 105 is therefore automatically optimized to function for an objective having an exit pupil distance of 70 mm, located to the object side of the image plane 106. However, the corrector 105 according to Example 5 may be used with good results with objectives 101 having exit pupil distances ranging from 45 mm to about 200 mm. In addition, although the corrector 105 is optimized for an f/1.4 objective 101, it may be used with good results with objectives as fast as f/1.2 or even f/1.0.

### Example 6

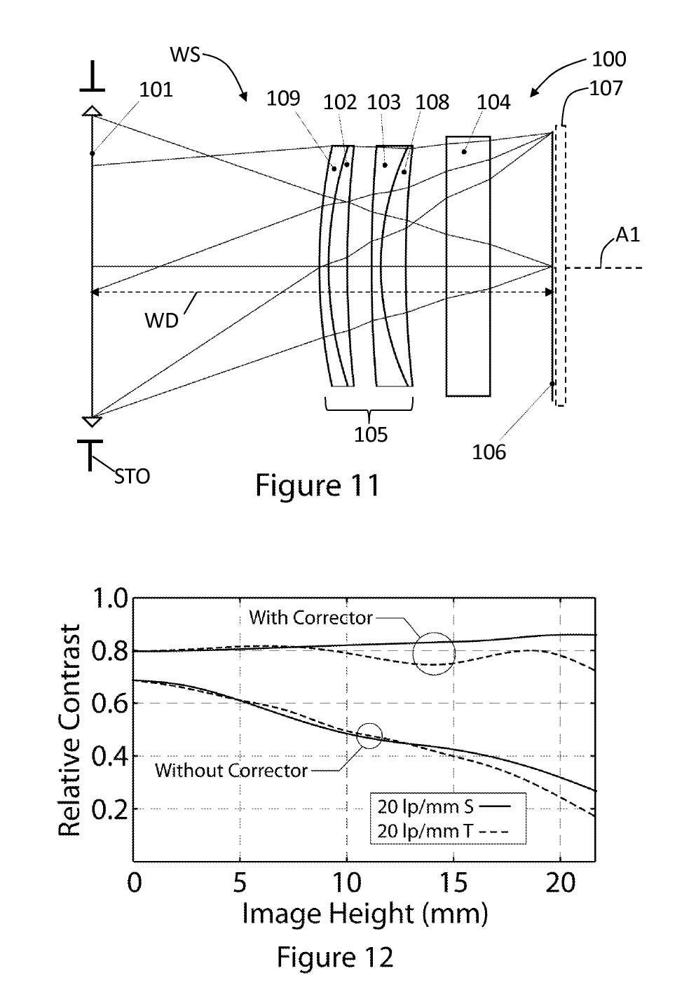

FIG. 11 shows a sixth example (Example 6) of imaging optical system 100, wherein corrector 105 is optimized for a large aperture (f/1.4) and large image diagonal (43.26 mm). Corrector 105 of Example 6 is thus suitable for use with a full-frame 35 mm format (24 mm×36 mm) objective 101.

Corrector 105 of Example 6 is also designed as a universal corrector. Corrector 105 comprises, in order along axis A1 from objective 101 to image plane 106, a meniscus negative element 109, a meniscus positive element 102 cemented to the image-facing surface of lens element 109, a meniscus negative element 103, and a meniscus positive element 108 cemented to the image-facing surface of lens element 103.

To maximize the use of the available working space WS, corrector 105 has slightly negative optical power. This in turn requires that the positive elements 102 and 108 be made from a material having a lower index of refraction than the negative element 103 to avoid introducing backward field curvature. As a result, the image plane 106 can be planar.

FIG. 12 shows two different plots of MTF vs. Image Height at a spatial frequency of 20 lp/mm. The two plots are shown on the same graph so that they may be easily compared. The relative contrast for sagittal S and tangential T rays are shown as solid and dashed lines, respectively. The first plot, labeled “Without Corrector” shows how a 70 mm EFL perfect lens is degraded by the presence of a 7 mm thick flat plate 104 made of S-BSL7 glass having a refractive index of 1.51633. The second plot, labeled “With Corrector” shows how corrector 105 dramatically improves the performance of objective 101 when the flat plate 104 is used.

Detailed prescription data for Example 6 is set forth in Table 6A below. Specification data for Example 6 is given in Table 6B below. Note that all optical surfaces are either spherical or plano. The perfect lens can be conveniently modeled as a paraxial lens using Zemax optical design software.

TABLE 6A
Prescription Data for Example 6

| | | | | GLASS | |
|---|---|---|---|---|---|
| S# | TYPE | R | T | (n_{d}, ν_{d}) | D |
| OBJ | | INF | INF | | |
| STO | PAR | INF | 36.5 | | |
| | (EFL = 70 mm) | | | | |
| 2 | SPH | 93.302 | 1.500 | 1.43875, 94.9 | 39 |
| 3 | SPH | 62.136 | 3.000 | 1.72000, 50.2 | 39 |
| 4 | SPH | 178.402 | 3.886 | | 39 |
| 5 | SPH | 237.331 | 1.500 | 1.88300, 40.8 | 39 |
| 6 | SPH | 45.363 | 4.000 | 1.53172, 48.8 | 39 |
| 7 | SPH | 172.755 | 6.542 | | 39 |
| 8 | SPH | INF | 7.000 | 1.51633, 64.1 | 42.0 |
| 9 | SPH | INF | 10.002 | | 42.0 |
| IMG | FLT | INF | | | 43.26 |

TABLE 6B
Specification Data for Example 6
EXAMPLE 2 - SPECIFICATIONS

| | |
|---|---|
| Corrector Magnification | 0.979x |
| Corrector Power (diopters) | −1.46 |
| Aperture Ratio | f/1.4 |
| Ro | 93.302 |
| Ri | 172.755 |
| C = (1/Ro + 1/Ri) · Ro | 1.540 |
| Image Diagonal | 43.26 mm |

By placing the aperture stop STO at the (paraxial) 70 mm EFL objective 101, the exit pupil is thus located 70 mm from the image plane when no corrector is in place. The corrector 105 is therefore automatically optimized to function for an objective having an exit pupil distance of 70 mm, located to the object side of the image plane 106. However, the corrector 105 according to Example 6 may be used with good results with objectives 101 having exit pupil distances ranging from 45 mm to about 200 mm. In addition, although the corrector 105 is optimized for an f/1.4 objective 101, it may be used with good results with objectives as fast as f/1.2 or even f/1.0.

It will be apparent to those skilled in the art that various modifications to the preferred embodiments of the disclosure as described herein can be made without departing from the spirit or scope of the disclosure as defined in the appended claims. Thus, the disclosure covers the modifications and variations provided they come within the scope of the appended claims and the equivalents thereto.

What is claimed is:

1. A corrective optical system for an imaging optical system having an objective and an image plane, consisting of:
a first lens element that is bi-convex and having positive power and a refractive index n_{P};
a second lens element that is bi-concave and having negative power and a refractive index n_{N}, wherein n_{P}<n_{N};
wherein the first and second lens elements define an optical power P in the range −4 diopters<P<1 diopter; and
wherein the first and second lens elements reduce aberrations in the imaging optical system when at least one flat plate is introduced adjacent the image plane and when the first and second lens elements are operably disposed between the objective and the at least one flat plate.

2. The corrective optical system according to claim 1, wherein the first lens element defines a most objective-wise lens surface having a radius of curvature Ro, the second lens element defines a most image-plane-wise lens surface having a radius of curvature Ri, and wherein 0<((1/Ro)+(1/Ri))·Ro<3.

3. The corrective optical system according to claim 2, wherein the objective has a focal length f_{O}, the imaging optical system comprising the objective together with the corrective optical system has a focal length of f_{S}, and wherein 0.85<|f_{S}/f_{O}|<1.20.

4. The corrective optical system according to claim 1, wherein the corrective optical system is removably attached to the objective.

5. The corrective optical system according to claim 1, wherein the corrective optical system is permanently attached to the objective.

6. The corrective optical system according to claim 1, wherein the corrective optical is removably attached to a camera that includes the flat plate.

7. The corrective optical system according to claim 1, wherein the corrective optical system is permanently attached to a camera that includes the flat plate.

8. An imaging optical system having an image plane, comprising in order along an optical axis:
an objective having a working space and that is corrected for aberrations in the absence of one or more flat plates within the working space;
one or more flat plates arranged in the working space and adjacent the image plane;
a corrective optical system arranged within the working space and between the one or more flat plates and the objective, the corrective optical system having an optical power P in the range −4 diopters<P<1 diopter and a magnification M in the range 0.8≦M≦1.2; and
wherein the one or more flat plates introduce aberrations into the imaging optical system, and wherein the corrective optical system acts to reduce the aberrations.

9. The imaging optical system according to claim 8, wherein the corrector optical system is universal.

10. The imaging optical system according to claim 8, wherein the corrector optical system has from one to four lens elements.

11. The imaging optical system according to claim 10, wherein the one to four lens elements define a most objective-wise lens surface having a radius of curvature Ro and a most image-plane-wise lens surface having a radius of curvature Ri, and wherein 0<((1/Ro)+(1/Ri))·Ro<3.

12. The imaging system according to claim 11, wherein the one to four lens elements consist of a single meniscus lens element.

13. The imaging optical system according to claim 8, wherein the one to four lens elements consist of a first lens element that is bi-convex and having positive power and a refractive index n_{P}, and a second lens element that is bi-concave and having negative power and a refractive index n_{N}, and wherein n_{P}<n_{N}.

14. The imaging optical system according to claim 8, further comprising an electronic image sensor arranged at the image plane.

15. An imaging optical system, comprising in order along an optical axis:
an objective having an image side with a working space, the objective having an imaging performance that assumes there are no plane parallel plates in the working space;
a corrective optical system arranged on the image side of the objective, the corrective optical system having one to four lens elements and a magnification M in the range 0.85≦M≦1.2;
at least one plane parallel plate arranged between the corrective optical system and the image plane and that introduces into the imaging optical system aberrations that that reduce the imaging performance;
an electronic image sensor arranged substantially at the image plane; and
wherein the corrective optical system reduces the aberrations introduced into the objective by the one or more plane parallel plates to substantially restore the imaging performance of the objective.

16. The imaging optical system according to claim 15, wherein the electronic image sensor and the at least one plane parallel plate are housed in a camera housing, and wherein the corrective optical system is adapted to be removably attached to the camera housing, and wherein the objective is adapted to be removably attached to the corrective optical system.

17. The imaging optical system according to claim 15, wherein the corrective optical system has an optical power P in the range −4 diopters<P<1 diopter.

18. The imaging optical system according to claim 15, wherein the one to four lens elements consist of a first lens element that is bi-convex and having positive power and a refractive index n_{P}, and a second lens element that is bi-concave and having negative power and a refractive index n_{N}, and wherein n_{P}<n_{N}.

19. The imaging optical system according to claim 15, wherein the one to four lens elements define a most objective-wise lens surface having a radius of curvature Ro and a most image-plane-wise lens surface having a radius of curvature Ri, and wherein 0<((1/Ro)+(1/Ri))·Ro<3.

20. The imaging system according to claim 15, wherein the one to four lens elements consist of a single meniscus lens element.

21. A method of employing an objective designed for use with film on a digital camera having a flat plate and an electronic image sensor, comprising:
attaching a corrective optical system to the digital camera;
attaching the objective to the corrective optical system so that the corrective optical system operably resides between the objective and the flat plate; and
wherein the flat plate introduces aberrations to the objective, and wherein the corrective optical system acts to reduce the aberrations.

22. The method according to claim 21, wherein the corrective optical system has from one to four lens elements.

23. The method according to claim 22, wherein the one to four lens elements define a most objective-wise lens surface having a radius of curvature Ro and a most image-plane-wise lens surface having a radius of curvature Ri, and wherein 0<((1/Ro)+(1/Ri))·Ro<3.

24. The imaging system according to claim 22, wherein the one to four lens elements consist of a single meniscus lens element.

25. The method according to claim 21, wherein the digital camera comprises a 35 mm camera.

26. The method according to claim 22, wherein the one to for lens elements consist of a bi-convex lens element having positive power and a refractive index n_{P}, and a bi-concave lens element and having negative power and a refractive index n_{N}, and wherein n_{P}<n_{N}.

27. The method according to claim 21, wherein the corrective optical system has an optical power P in the range −4 diopters<P<1 diopter and a magnification in the range 0.85≦M≦1.2.

28. A corrective optical system for an imaging optical system having an objective with a working space and an image plane, comprising:
one to four lens elements that define a most objective-wise lens surface having a radius of curvature Ro and a most image-plane-wise lens surface having a radius of curvature Ri;
wherein 0<((1/Ro)+(1/Ri))·Ro<3; and
wherein the one to for lens elements act to reduces aberrations in the imaging optical system when at least one flat plate resides in the workspace adjacent an image plane and when the corrective optical system is operably disposed in the working space between the objective and the at least one flat plate.

29. The corrective optical system according to claim 28, wherein the one to four lens elements define an optical power P in the range −4 diopters<P<1 diopter and a magnification in the range 0.85≦M≦1.2.

30. The corrective optical system according to claim 28, wherein the one to four lens elements consist of a first objective-wise lens element that is bi-convex and having positive power and a refractive index n_{P}, and a second image-plane-wise lens element that is bi-concave and having negative power and a refractive index n_{N}, and wherein n_{P}<n_{N}.

31. The corrective optical system according to claim 28, wherein the one to four lens elements consist of a single meniscus lens element.

32. The corrective optical system according to claim 28, wherein the one to four lens elements consist of a most objective-wise meniscus lens element and a most image-plane-wise doublet.

33. The corrective optical system according to claim 28, wherein the one to four lens elements consist of two doublets.

34. The imaging optical system according to claim 28, further comprising an electronic image sensor arranged at the image plane.
